(19) United States
(12) Patent Application Publication
(10) Pub. No.: US 2010/0182106 A1
(43) Pub. Date: Jul. 22, 2010

(54) DIRECT CURRENT VOLTAGE ISOLATOR

(76) Inventors: Karl Schneider, Hannover (DE); Volker Hurm, Merzhausen (DE); Herbert Walcher, Freiburg (DE); Ronny Kolbe, Darmstadt (DE)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/596,190

(22) PCT Filed: Apr. 16, 2008
(86) PCT No.: PCT/EP08/03024

§ 371 Date: Feb. 24, 2010

(30) Foreign Application Priority Data
Apr. 16, 2007 (DE) 10 2007 018 120.7

(51) Int. Cl. H01P 5/02

(52) U.S. Cl. 333/24 C

(57) ABSTRACT

An isolation amplifier with at least one ground line and at least one signal conducting line, separated by an insulator with a capacitor arranged in the signal conducting line in a region in which the surface of the signal conducting line facing the insulator is greater than the surface of the ground line facing the insulator.

The invention relates to a direct current voltage isolator with at least one ground conductor and at least one signal-carrying conductor, which are arranged in such a way that they are spaced apart by means of an isolator, whereby a capacitor is arranged in the signal-carrying conductor. Such direct current voltage isolators separate or superpose the time-dependent portion and the direct voltage portion of an electrical signal. For this purpose, an additional connection point is provided on one or both contacts of the capacitor, by means of which contacts the direct voltage portion is fed in or taken away. Another common name for this component is “Bias-T”.

According to the state of the art, a Bias-T separates the direct voltage portion (DC) and the time-dependent portion (HF) of an electric signal from each other. An ideal Bias-T is a 3-gate that contains an infinitely large capacitor C and an infinitely large inductor L, cf. FIG. 1. The superimposition of the DC and HF signals is applied or removed by gate 1. The inductor allows only a DC signal to pass, the capacitor, on the other hand, allows only an HF signal to pass. As a result, the signal path of the DC portion runs from gate 1 to gate 3, and the signal path of the HF portion runs from gate 1 to gate 2. If the inductor and gate 3 are eliminated, the Bias-T can be used for direct current voltage isolation from gate 1 to gate 2.

A real Bias-T exhibits only finite values for the capacitor C and the inductor L, however. This results in a finitely large lower cut-off frequency f_{g1}. Below this cut-off frequency, the HF signal is strongly attenuated on its way from gate 1 to gate 2. Because the capacitive resistance x_{c} of an alternating current (AC) circuit behaves in accordance with the formula

$${X}_{c} = \frac{1}{2 π f \cdot C}$$

this capacitive resistance declines as the frequency increases. As a result, no upper cut-off frequency for a Bias-T is to be expected from the theory.

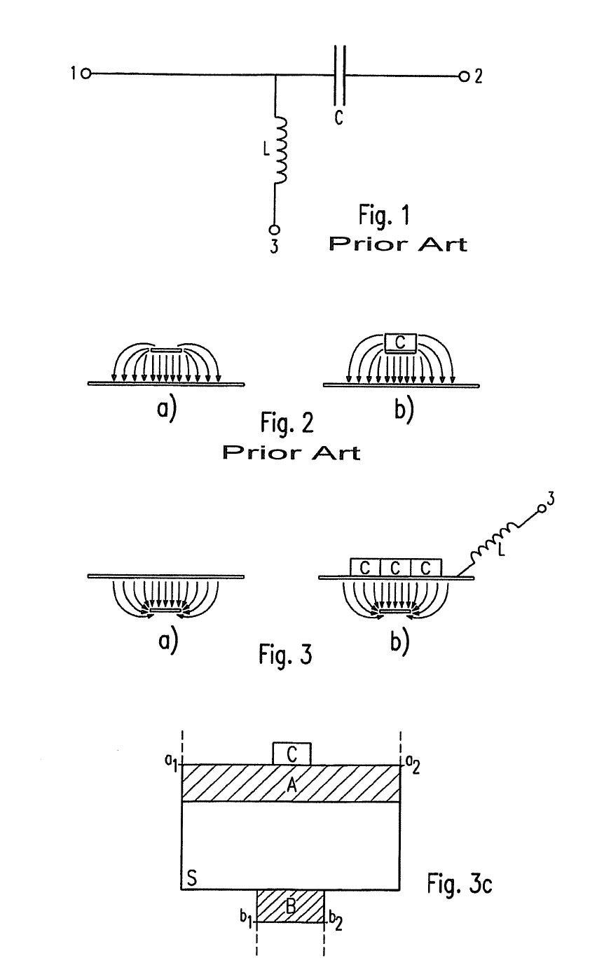

It has been seen, however, that the space surrounding the signal conductor is almost completely filled by the electromagnetic field of the conducted wave, cf. FIG. 2. Because a real capacitor also has outer geometric dimensions that increase as the capacitance increases, the presence of the component interferes with the field distribution in its surroundings. The capacitor consequently represents a discontinuity in the waveguide, which causes reflections. The higher the frequencies, or the smaller the wavelengths of the propagating waves, the stronger the transmission interference is that is caused by this discontinuity. For this reason, large capacitors can limit the upper cut-off frequency f_{g2}.

If an inductor is provided between gate 1 and gate 3, this inductor also causes an upper cut-off frequency f_{g2}. A real inductor exhibits finite dimensions. Like the capacitor, it therefore causes a discontinuity in the waveguide with the negative effects described above.

A real inductor furthermore also exhibits finite values for the capacitance and the ohmic resistance. It can therefore be described as a network of a plurality of ideal components. This network exhibits at least one resonant frequency at which it has the effect of a short circuit, as the result of which it causes at least one minimum in the transmission of the HF signal. In order to achieve the highest possible upper cut-off frequency f_{g2}, this resonant frequency must be high. As a rule, the resonant frequency of an inductor increases as its dimensions decrease. This, however, causes the cross-sectional area of the current conductor to become small, and the ability to be loaded with a DC current is restricted.

To solve this problem, DE 103 08 211 A1 suggests conducting the electromagnetic wave on an internal conductor, which is surrounded by a gapless, essentially coaxial external conductor. The internal conductor is separated by a gap at a separation point. This separation point is bridged with a capacitor. In order to interfere with the field distribution in the coaxial conductor arrangement as little as possible, the capacitor is inserted into the internal conductor in this case. This arrangement does not, however, solve the problem of additionally contacting a side of the capacitor with a coil without interfering with the transmission.

GB 2 189 942 A describes a Bias-T which is implemented by means of microstrip lines of various widths. According to this state of the art, the microstrip line between gate 1 and gate 2 becomes continually wider, as a result of which its impedance drops. The inductor between gate 1 and gate 3 is formed by a very narrow microstrip line with high impedance. This prevents the HF signal from running through the narrow microstrip line to gate 3. After the DC current has been fed in, the width of the microstrip line gets smaller, so that the impedance returns to the original value. Because of the short effective line length, DC currents can be fed in at somewhat increased upper cut-off frequencies. Because the Bias-T does not have any capacitor, however, it cannot be used for separating a DC signal and an HF signal.

The object of the present invention accordingly consists of providing a direct current voltage isolator or a direct voltage feed with expanded bandwidth. The object of the present invention furthermore consists of providing a direct voltage feed which exhibits a higher upper cut-off frequency and an increased maximum DC current than what is found in the state of the art.

The invention is solved by means of a direct current voltage isolator with at least one ground conductor and at least one signal-carrying conductor, which are arranged in such a way that they are spaced apart by means of an isolator, whereby a capacitor is arranged in the signal-carrying conductor in an area in which the surface of the signal conductor facing toward the isolator is larger than the surface of the ground conductor facing toward the isolator.

In the context of the invention, the surfaces of the envelopes are to be understood as the surface of the signal conductor and ground conductor facing toward the isolator. In the cross-section of the conductor arrangement, the envelope here is the curve with a minimum circumference which completely encloses the cross-section of the respective conductors.

In the context of the present patent application, an isolator is considered to be any material that prevents a direct galvanic current flow between the signal-carrying conductor and the ground conductor. For example, the isolator can consist of an air gap or a protective gas. In particular, however, the use of a dielectric solid body is considered. The dielectric constant preferably amounts to between roughly 1 and roughly 13 in this case. More preferable is the use of polytetrafluoroethylene (PTFE) and/or GaAs and/or quartz and/or InP. The Bias-T can be monolithically integrated with an amplifier on a substrate on a semiconducting dopable isolator in a particularly simple manner.

Depending on the case, combinations of a plurality of materials, either as an alloy or as a layered structure, can be used as the insulator.

In electrical and telecommunications engineering, the assumption for decades has been that the signal conductor in a waveguide has smaller dimensions than the ground conductor or ground conductors. For example, coaxial transmission lines consist of a thin signal conductor, which is arranged in the symmetry axis of the line. This is externally surrounded by a cylindrical ground conductor. On printed circuit boards (PCBs), a narrow copper conductor from 0.3 to 1 mm is used as the signal conductor, whereas usually the entire back of the PCB is available as the ground line, or two ground conductors are arranged one on either side of the signal conductor. According to the invention, it is now recognized that the objects of the present invention can be solved by means of breaking with this paradigm.

According to the invention, an enlarged signal conductor is used, which is opposed by only a small ground conductor. As a result of this reversal of the geometry, the electronic elements which form the capacitor C of a Bias-T can be arranged in a spatial area in which they do not noticeably interfere with the field distribution of the propagating HF wave. This is due to the fact that the broader conductor of an HF line always completely shields the field of the propagating wave, whereas edge effects arise at the narrower conductor, so that this conductor is encompassed by the field of the propagating wave.

The object of the invention is consequently solved by a direct current voltage isolator with a ground conductor and a signal-carrying conductor, whereby a capacitor is arranged on the signal-carrying conductor, characterized in that that the dimensions of the signal-carrying conductor and the dimensions of the ground conductor are executed in such a manner that the signal-carrying conductor shields the electric field strength of the propagating alternating voltage signal in such a way that there is an area at the surface of the signal conductor in which the amplitude of the electric field strength of the alternating voltage signal is lower than the amplitude of the electric field strength of the alternating voltage signal that arises at the surface of the ground conductor, and in that the capacitor is arranged in the area of the signal-carrying conductor that is shielded in this way.

The electric field strength is accessible through calculations. If the waveguide structure is known, or, in other words, if the exact dimensions of the ground conductor and the signal-carrying conductor are known, the electric field strength can be calculated at any point on the waveguide structure. On the basis of the dimensions selected according to the invention for the ground conductor and the signal-carrying conductor, there are areas at the signal-carrying conductor in which the amplitude of the electric field strength of the alternating voltage signal is lower than the amplitude of the electric field strength that arises at the surface of the ground conductor. The consideration and the comparison of the alternating voltage signal electric field strength amplitudes arising or calculated at the surface of the conductors is done at the same place. At the same place means that a cross-section orthogonal to the direction of propagation of the propagating alternating voltage signal is considered.

FIG. 3a is shown here to illustrate this. FIG. 3a is a cross-section orthogonal to the direction of propagation of the alternating voltage signal through a waveguide structure according to the invention. It is seen that in the case of the signal-carrying conductor (the upper conductor in this case), there is an area on the side facing away from the ground conductor where the electric field strength is lower than what can be found on the surface of the ground conductor. The surface is the interface between the conductor and the insulator surrounding it. The ground conductor is encompassed by the field lines and consequently there is no point on its surface (neither on the side facing toward the signal-carrying conductor nor on the side facing away from the signal-carrying conductor) with an alternating voltage signal electric field strength amplitude that is lower than that in the shielded area at the signal-carrying conductor. In the example shown in FIG. 3a, the shielded area at the signal-carrying conductor is on the side/surface of the signal-carrying conductor facing away from the ground conductor.

The signal-carrying conductor is now separated for the purpose of direct current isolation, with the result that a gap arises, whereby this gap is bridged with a capacitor or with capacitors. The gap which is introduced into the signal-carrying conductor for the purpose of bringing about the direct current voltage isolation interferes with the shielding capability of the signal-carrying conductor. Nevertheless, at a distance of only one or two gap widths from the gap (along the direction of propagation of the signal), a virtually field-free area arises again, so that the effect of these stray fields is negligible. Consequently, for the direct current voltage isolation, a certain conductor section along the direction of propagation is taken, whereby the dimensions of the waveguide structure along this section are executed according to the invention in such a way that a shielded area for the direct current voltage isolation is provided at the signal-carrying conductor. The capacitors for bridging the gap are built into this area of the signal-carrying conductor, meaning in an area in which they do not noticeably interfere with the field distribution of the propagating AC signal.

Surfaces of hollow spaces encapsulated in the conductor, or consequently hollow spaces secluded within a conductor in the manner of a Faraday cage, are not considered to be the surface of a conductor. FIG. 9 shows a cross-section of a conductor (L) that exhibits such a hollow space (H). The dashed line drawn in the hollow space (H) in the cross-section shows the surface of the encapsulated hollow space, whereby this is not taken into account in the comparison of the electric field strengths at the surface of the signal conductor and at the surface of the ground conductor.

In a further development of the direct current voltage isolator, it can be expanded into a complete Bias-T by means of connecting the signal-carrying conductor to an inductor and/or an ohmic resistor on at least one side of the capacitor. In this way, it is possible to superimpose the signal conductor with a direct current or a direct voltage or to conduct such a voltage away. As a result of the inductor, the direct current voltage isolator is also simultaneously a direct voltage feed. This expansion is particularly simple due to the arrangement of the waveguide structure according to the invention, because the inductors are also placed in the shielded area of the signal-carrying conductor.

In an especially preferred development of the direct current voltage isolator according to the invention, the capacitor and/or the inductor and/or the ohmic resistor consist of exactly one element, which is a capacitor, a coil or a film resistor, depending on the case. In this case, the direct current voltage isolator can have a particularly compact construction. It requires no supply voltage, and is consequently rugged and reliable.

In a further preferred embodiment, the capacitor and/or the inductor and/or the ohmic resistor can be formed by a network which comprises semiconductor components and/or resistors and/or capacitors and/or inductors. Using such networks, it is also possible to implement large values for the capacitance or inductive reactances, without having to accept the disadvantages of large and heavy components. In this way, for example, even at large inductive reactances, the ohmic resistance of a coil can be kept at a low level, or the dielectric power dissipation of high-capacitance capacitors is reduced by a network of a plurality of components.

The construction of the direct current voltage isolator in accordance with the present invention is more preferable if the components that are used are given SMD housings. Such components exhibit small geometric dimensions, as a result of which the influence of the components on the electric field distribution around the conductor arrangement is further reduced. Because there is no need to have bored holes for wire terminations, this embodiment does without a further source of errors at which reflections and losses of the HF signal could arise. SMD elements furthermore possess standardized housings of similar dimensions, which allow simple and reliable construction.

Particularly simple integration of the direct current voltage isolator according to the invention into existing surroundings then results if the side of the signal conductor facing toward the isolator incrementally or continually increases in size in the direction facing toward the capacitor and the surface of the ground conductor facing toward the isolator incrementally or continually decreases in size. In this case, the known narrow signal lines can continue to be used for a large portion of the signal transport on the electronic circuit. The ground surface lying opposite can also continue to be executed with a large surface. The proportions are reversed only in the area of the Bias-T, by means of the signal conductor being incrementally or continually expanded and the ground conductor being made narrower in correspondence to the increase in the signal conductor. The signal conductor is then preferably interrupted at its widest spot, whereby the resulting gap is bridged by means of at least one capacitor. The signal line is then again incrementally or continually reduced to the original value after the direct current voltage isolation and the ground line is widened in correspondence to the decrease in the signal line. The line's characteristic impedance remains constant across the Bias-T as a result of this adjustment of the conductor surfaces. In this way, reflections and deteriorations of the HF signal are reliable avoided. The person skilled in the art will determine the dimensions of the conductors for the particular case using known formulas, whereby the width essentially depends on the thickness and the relative dielectric constant depends of the dielectric used.

One of the particularly preferred possible applications of the Bias-T according to the invention is metrology, for example, on gallium nitride components and in amplifier technology, because special demands are placed on the bandwidth and/or the ability to be loaded with high direct currents in these areas. The direct current feed according to the invention can be integrated into an existing board layout with simple manufacturing methods in accordance with the state of the art. An amplifier module is consequently possible that amplifies the HF signal on the one hand while simultaneously impressing a direct voltage portion. Monolithic integration of the direct current voltage isolator with an amplifier on the same semiconductor wafer is also possible on a case by case basis. In this way, the line lengths and transitions are made smaller again and the interfering reflections of the HF signal are avoided.

In order to avoid interfering with the surrounding components and to avoid the radiation of unwanted high frequency signals into the direct current voltage isolator according to the invention, the entire arrangement can be surrounded by electrically conductive shielding or by a housing. More preferably, this is connected to the electric ground. In order for the electric field of the propagating HF wave to be concentrated between the signal and ground conductors, the person skilled in the art will, for example, provide a greater distance between the shielding and the signal conductor. As a result, only the smaller ground conductor is relevantly involved in the wave guidance of the HF signal, and the influence of the shielding is kept small.

Without restricting the general inventive concept, the invention is now explained in more detail using the following figures and embodiments. The respective waveguide structure dimensions according to the invention are shown in the embodiments.

FIG. 1 shows the electrical circuit of a direct voltage feed according to the state of the art.

FIG. 2 shows a schematic depiction of the electric field distribution of a microstrip line according to the state of the art, with and without a series capacitor C. The signal conductor is the upper conductor. The conductor shown at the bottom is the ground conductor.

FIG. 3 3 (a) shows an inverted microstrip line without interruption and 3 (b) shows an inverted microstrip line with a series capacitor C according to the present invention. The upper conductor is the signal conductor in FIG. 3a and FIG. 3b.

FIG. 3c shows a schematic depiction of a microstrip line according to the invention.

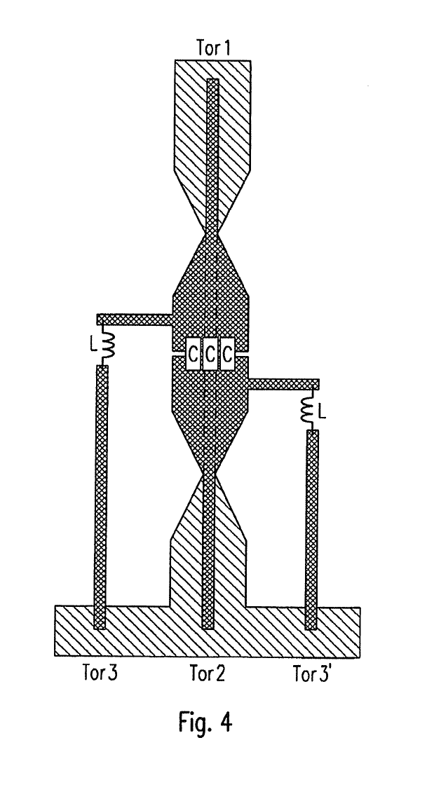

FIG. 4 shows a board layout with which the direct voltage feed according to the invention can be implemented as a microstrip line on a flat substrate.

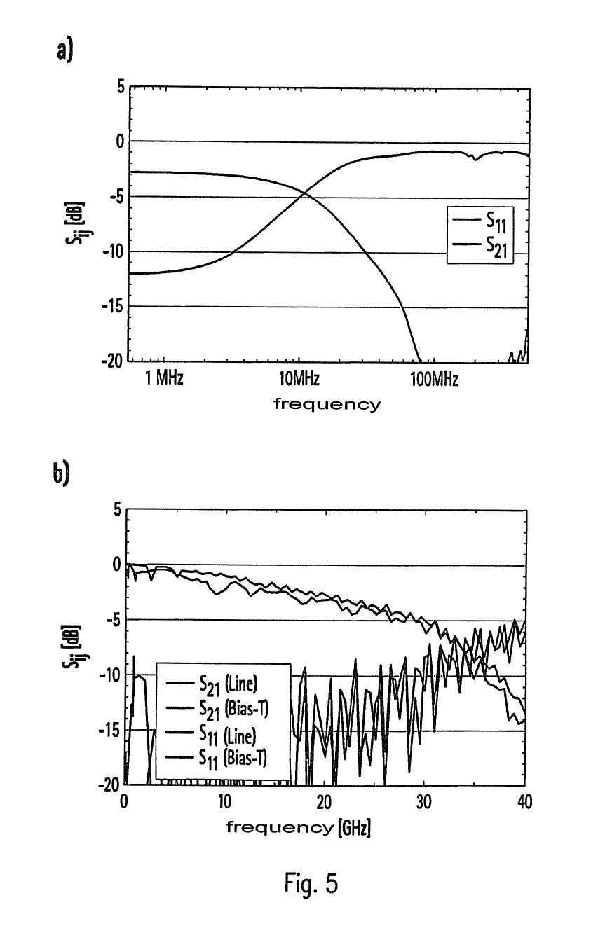

FIG. 5a shows the measured transmission and the adjustment of the direct voltage feed according to FIG. 4 in the frequency range of 500 kHz to 500 MHz.

FIG. 5b shows the same measurements in the frequency range from 500 MHz to 40 GHz. Measured values of a line piece are also entered for comparison.

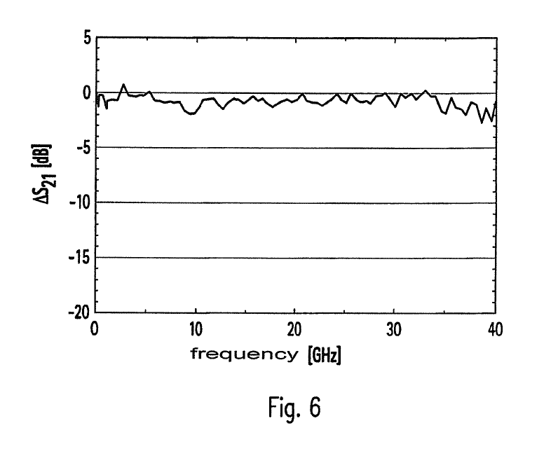

FIG. 6 shows the difference between the measured transmission of a reference line and the direct voltage feed according to FIG. 4 in the frequency range from 500 MHz to 40 GHz.

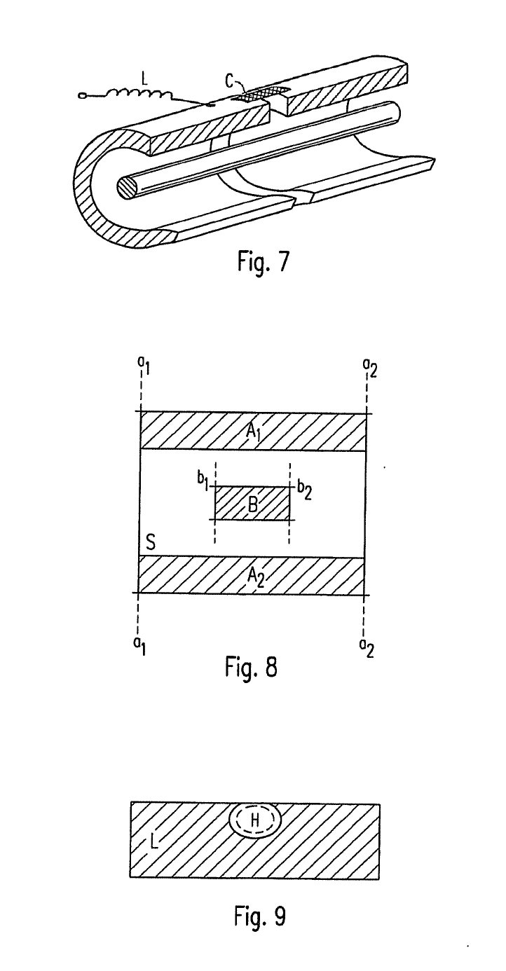

FIG. 7 shows a direct voltage feed according to the present invention, constructed as a coaxial transmission line.

FIG. 8 shows a schematic depiction of a symmetrical strip line according to the invention

FIG. 9 shows what is meant by a hollow space encapsulated in the conductor.

FIG. 2a shows a narrow signal line according to the state of the art, which line is arranged at a distance away from a wide ground line. A homogenous field distribution of the propagating wave forms between the two conductors. Curved field lies, which encompass the conductor, run at the edge of the narrow conductor. As a result, there are also field lines that run out from the upper side of the narrow signal conductor.

FIG. 2b represents the same conductor according to the state of the art with a series capacitor C in the cross-section. It can be clearly seen that the capacitor interrupts the field line course of the free conductor. This interference does not affect the signal quality at low frequencies up to several 100 MHz. At high frequencies of at least approximately 10 GHz, the series capacitor causes reflections, however, which cause deterioration of the signal to quality.

FIG. 3a shows a microstrip line in accordance with the present invention. This is characterized by the fact that the upper signal conductor is wider than the narrow ground conductor. This causes no change in the field distribution of the microstrip line, which is not interrupted. FIG. 3b shows the area of the direct voltage feed with capacitors C and an inductor L for the direct current feed. Unlike in the state of the art as shown in FIG. 2b, these are now arranged in the field-free area of the conductor arrangement. The field distribution consequently remains unchanged when compared to the line without interruption, even at the direct current feed. As a result, the occurrence of an upper cut-off frequency f_{g2} is prevented, as desired, by the capacitor C and the inductor L. Due to the larger line cross-section, larger capacitors with higher capacitances can be used, so that the lower cut-off frequency is also advantageously reduced.

In microstrip technology, the direct current voltage isolator is consequently implemented with a ground conductor and a signal-carrying conductor that are applied to a dielectric substrate in the form of strips. FIG. 3c shows a cross-section orthogonal to the propagation direction of the propagating alternating voltage signal through a microstrip conductor according to the invention. The ground conductor (B) is applied on the one side of the dielectric substrate (S) and the signal-carrying conductor (A) is applied on the other side of the dielectric substrate (S), whereby a capacitor (C) is arranged on the side of the signal-carrying conductor (A) facing away from the substrate, characterized in that the signal-carrying conductor (A) is wider than the ground conductor (B). Wider means that the path that connects the two outermost points a₁ and a₂ of the metallization of the signal-carrying conductor (A) is wider than the path that connects the two outermost points b₁ and b₂ of the metallization of the ground conductor (B).

FIG. 4 shows the board layout of a direct voltage feeder according to the present invention and implemented in microstrip technology. The figure shows the surface metallization in gray and the reverse side metallization in black. On the upper side, the signal conductor is formed as a narrow strip conductor in the area at the left while the ground conductor lying opposite is considerably wider than the signal conductor. In the middle area, the direct current feed is implemented with three capacitors for direct current voltage isolation. The direct voltage is fed in or taken away on the two sides of the capacitors using inductors L.

In this middle area with the electronic components, the signal line is considerably wider than the ground line. For this purpose, the signal line is continually widened until it has reached the width of the original ground conductor. The ground conductor is reduced in the same surface area according to the width of the signal conductor, until the width of the ground conductor has reached the width of the original signal conductor. Because the characteristic impedance of such a microstrip arrangement is a function of the conductor width, the PCB thickness and the relative dielectric constant, the impedance of the line is not changed by this change in the conductor width, as shown by the measurement results given in FIG. 5 and FIG. 6. The field of the electromagnetic wave, which is always localized between the wide and the narrow conductors, consequently wanders from the top side of the PCB to the bottom side in the area of the transition. In the area of the capacitors C and the direct current feeds, which are arranged on the upper side of the PCB, the conductor is consequently field-free.

The board layout shown in FIG. 4 was implemented on a PCB substrate with a thickness of 508 μm with copper metallization on the upper and lower sides, each 17 μm thick. The substrate material was a commercially available, fiber-glass-reinforced PTFE material with a dielectric constant ∈ₓ=3.38 at a frequency of 10 GHz. The dielectric loss at this frequency was 0.0027. The entire PCB has a width of 4 cm and a length of 7.3 cm. Of this, an area of 2×7.3 cm² is occupied by the Bias-T. An additional area of 2×7.3 cm² supports a straight reference line of uniform width without additional components.

FIG. 5a shows a measurement of the scattering parameters (S-parameters) in the range from 500 kHz to 500 MHz. S-parameters are used to describe the characteristics of linear time-invariant networks at high frequencies, because the variable quantities, current and voltage, are very difficult to measure. S-parameters describe the magnitude and phase of signal parts that are transmitted or reflected at various gates of a network. As shown in FIG. 5, transmission with virtually no interference is possible from gate 1 to gate 2 of the Bias-T at a frequency of 25 MHz or higher. The lower limit of the bandwidth is a function of the inductor used.

FIG. 5b shows the measurement of the S-parameters for the frequency range from 500 MHz to 40 GHz. The data of the same length of microstrip line without additional components are shown for comparison. Both the reference line and the direct voltage feed according to the invention show a transmission that continually drops off at higher frequencies.

It can be seen from FIG. 5b that the Bias-T according to the invention transports the signal with the same quality as the straight reference line without additional components. The signal deterioration seen until now to through a direct voltage feed no longer arises with the board layout according to the invention.

These facts are shown again in FIG. 6. The diagram shows the difference between the measured transmissions from FIG. 5 for the reference line and those for the direct voltage feed seen in FIG. 4. This difference is almost zero at a frequency of 35 GHz, and a difference of 2 dB can be measured at 35 GHz or more.

FIG. 7 shows an alternative embodiment of the direct current feed according to the invention, in coaxial form. As was already the case for the microstrip line, there is again a break with the paradigm known from the state of the art in that the ground line represents the larger-scale line. According to the invention, the internal conductor, arranged at the axis of symmetry, is used as the ground conductor. This is surrounded by an essentially cylindrically-shaped insulating material. The likewise essentially cylindrically-shaped signal conductor is mounted externally on the insulating material as a hollow cylindrical external conductor. The field distribution inside the coaxial transmission line consequently does not differ from the field distribution according to the state of the art. The externally-arranged signal conductor allows components for direct current voltage isolation and direct voltage feed or removal to be placed in the field-free area outside the coaxial conductor. For this purpose, the external conductor is separated and the resulting gap is bridged with capacitors. The gap that is introduced into the signal-carrying conductor for the purpose of bringing about the direct current voltage isolation interferes with the shielding capability of the externally-arranged signal-carrying conductor. Nevertheless, at a distance of only one or two gap widths from the gap, a virtually field-free area arises again, so that the effect of these stray fields is negligible. Depending on the material of the external conductor, the capacitors can be placed on the outside of the external conductor or, given a greater thickness of the material of the external conductor, they can also be countersunk into this material.

FIG. 8 shows an additional embodiment of the direct current voltage isolator according to the invention, namely in the form of the symmetrical strip line. In the case of the symmetrical strip line according to the state of the art, the signal-carrying conductor strip is embedded in a dielectric and runs parallel to two conductive layers that are placed on the two opposing sides of the dielectric and that serve as ground conductors. According to the invention, this arrangement is now changed in such a way (see FIG. 8) that the two external conductive layers (A₁, and A₂), which are placed on the two opposing sides of the dielectric, represent the signal-carrying conductor and the conductor (B) embedded in the dielectric is the ground conductor. The conductors (A₁ and A₂) placed on the opposing sides of the dielectric, or, in other words, the signal-carrying conductors (A₁ and A₂), are wider than the ground conductor (B). According to FIG. 8, this means that the section between a₁ and a₂ is wider than the section between b₁ and b₂. At the same time, a₁ and a₂ are each the respective outermost points of the metallization of the signal-carrying conductors A₁ and A₂, and b₁ and b₂ are likewise the outermost points of the metallization of the ground conductor. For direct current voltage isolation, a gap is now introduced into the signal-carrying conductors A₁ and A₂ along a₁ and a₂. The capacitors for the direct current voltage isolation are arranged on the side of the signal-carrying conductors A₁ and A₂ facing away from the substrate, in the immediate vicinity of the gap.

1.-19. (canceled)

20. A Direct current voltage isolator comprising at least one ground conductor, at least one insulator, at least one capacitor and at least one signal-carrying conductor, wherein the capacitor is arranged on the signal-carrying conductor in a location in which the surface area of the signal-carrying conductor facing toward the isolator is larger than the surface area of the ground conductor facing toward the isolator, such that the signal-carrying conductor is adapted to shield the electric field of the propagating alternating voltage signal in such a way that there is a location at the surface opposite to the isolator of the signal conductor in which the amplitude of the electric field strength of the alternating voltage signal is lower than the amplitude of the electric field strength of the alternating voltage signal that arises at the surface opposite to the isolator of the ground conductor.

21. The direct current voltage isolator according to claim 20 comprising further at least one inductor and/or at least one ohmic resistor, wherein the signal-carrying conductor is coupled to the inductor and/or the ohmic resistor on one side of the capacitor.

22. The direct current voltage isolator according to claim 21, wherein the capacitor and/or the inductor and/or the ohmic resistor consists of exactly one capacitor, coil or film resistor.

23. The direct current voltage isolator according to claim 20, wherein the capacitor and/or the inductor and/or the ohmic resistor is formed by a network which comprises any of at least one semiconductor component and/or at least one resistor and/or at least one capacitor and/or at least one inductor.

24. The direct current voltage isolator according to claim 23 wherein the semiconductor component and/or resistor and/or capacitor and/or inductor are provided with SMD housings.

25. The direct current voltage isolator according to claim 20 wherein the insulator exhibits a dielectric constant of roughly 1 to roughly 13.

26. The direct current voltage isolator according to claim 25, wherein the insulator exhibits a dielectric constant of roughly 3 to roughly 10.

27. The direct current voltage isolator according to claim 20 wherein the surface area of the signal-carrying conductor facing toward the insulator increases in the direction of the capacitor and the surface area of the ground conductor facing toward the insulator decreases.

28. The direct current voltage isolator according to claim 20 wherein the ground conductor and the signal-carrying conductor are arranged on opposing sides of a flat insulator.

29. The direct current voltage isolator according to claim 20 wherein the ground conductor and the signal-carrying conductor are arranged on the same side of a flat insulator.

30. The direct current voltage isolator according to claim 20 wherein the ground conductor is surrounded by a cylindrically-shaped insulator that is, in turn, surrounded by a cylindrically-shaped signal-carrying conductor.

31. The direct current voltage isolator according to claim 30 wherein the cylindrically-shaped signal-carrying conductor is assembled from wire mesh.

32. The direct current voltage isolator according to claim 20 wherein the at least one ground conductor and the at least one signal-carrying conductor are surrounded by an additional conductor.

33. An amplifier with a direct current voltage isolator according to claim 20.

34. The amplifier according to claim 33 comprising GaN and/or GaAs.

35. A Direct current voltage isolator comprising a ground conductor, an insulator, at least one capacitor, a signal-carrying conductor, at least one inductor and/or at least one ohmic resistor, wherein the capacitor is arranged on the signal-carrying conductor in a location in which the surface area of the signal-carrying conductor facing toward the isolator is larger than the surface area of the ground conductor facing toward the isolator, such that the signal-carrying conductor is adapted to shield the electric field of the propagating alternating voltage signal in such a way that there is a location at the surface opposite to the isolator of the signal conductor in which the amplitude of the electric field strength of the alternating voltage signal is lower than the amplitude of the electric field strength of the alternating voltage signal that arises at the surface opposite to the isolator of the ground conductor and the inductor and/or the ohmic resistor is coupled to the signal-carrying conductor on one side of the capacitor.

36. The direct current voltage isolator according to claim 35, wherein the capacitor and/or the inductor and/or the ohmic resistor consists of exactly one capacitor, coil or film resistor.

37. The direct current voltage isolator according to claim 35, wherein the capacitor and/or the inductor and/or the ohmic resistor is formed by a network which comprises any of at least one semiconductor component and/or at least one resistor and/or at least one capacitor and/or at least one inductor.

38. The direct current voltage isolator according to claim 35 wherein the insulator exhibits a dielectric constant of roughly 1 to roughly 13.

39. The direct current voltage isolator according to claim 38, wherein the insulator exhibits a dielectric constant of roughly 3 to roughly 10.

40. The direct current voltage isolator according to claim 35 wherein the surface area of the signal-carrying conductor facing toward the insulator increases in the direction of the capacitor and the surface area of the ground conductor facing toward the insulator decreases.

41. The direct current voltage isolator according to claim 35 wherein the ground conductor and the signal-carrying conductor are arranged on opposing sides of a flat insulator.

42. The direct current voltage isolator according to claim 35 wherein the ground conductor and the signal-carrying conductor are arranged on the same side of a flat insulator.

43. The direct current voltage isolator according to claim 35 wherein the ground conductor is surrounded by a cylindrically-shaped insulator that is, in turn, surrounded by a cylindrically-shaped signal-carrying conductor.

44. A method for measuring a high frequency signal, the method comprising the step of coupling the signal to at least one direct current voltage isolator, wherein the direct current voltage isolator comprises at least one ground conductor, at least one insulator, at least one signal-carrying conductor, and at least one capacitor, said capacitor being arranged on the signal-carrying conductor in a location in which the surface area of the signal-carrying conductor facing toward the isolator is larger than the surface area of the ground conductor facing toward the isolator, such that the signal-carrying conductor shields the electric field of the propagating alternating voltage signal in such a way that there is an area at the surface opposite to the isolator of the signal conductor in which the amplitude of the electric field strength of the alternating voltage signal is lower than the amplitude of the electric field strength of the alternating voltage signal that arises at the surface opposite to the isolator of the ground conductor.

45. The method according to claim 44, wherein a direct current is fed to the signal-carrying conductor by means of at least one inductor and/or an ohmic resistor coupled to one side of the capacitor.
